(19) United States
(12) Patent Application Publication
(10) Pub. No.: US 2015/0125106 A1
(43) Pub. Date: May 7, 2015

(54) THRUST NUT FOR BEARING AGAINST AN AXLE

(71) Applicant: Tsai-Chi Lin, Taichung City (TW)

(72) Inventor: Tsai-Chi Lin, Taichung City (TW)

(21) Appl. No.: 14/074,682

(22) Filed: Nov. 7, 2013

(51) Int. Cl. B60B 27/00; F16C 19/12

(52) U.S. Cl. CPC B60B 27/0078; F16C 19/12; B60B 27/0005
USPC 384/615

(57) ABSTRACT

A thrust nut for bearing against an axle includes a nut body, a first race member and a row of rolling elements. The nut body has opposing first and second surfaces and defines a threaded hole therein. The first race member is arranged to face the first surface of the nut body. The nut body serves as a second race member and cooperates with the first race member to co-define an annular track therebetween. The row of rolling elements is disposed in the annular track between the first race member and the nut body.

### BACKGROUND OF THE INVENTION

1. Field of the Invention

The present invention relates to a nut and more particularly to a thrust nut for axially bearing against an axle.

2. Description of the Related Art

A thrust bearing is a particular type of rotary bearing. Like other bearings they permit rotation between parts, but they are designed to support a predominately axial load. As shown in FIG. 5, a conventional thrust bearing 91 is retained by a nut 92 to support an axial load generated by an axle 94 of a pedal 9 of a bicycle. Specifically, the thrust bearing 91 is disposed around a distal end of the axle 94 and the nut 92 is threaded onto the end of the axle 94. The thrust bearing 91 includes a pair of race members 95, 96 and a row of balls 97 sandwiched in between the race members 95, 96. One of the race members 95 abuts indirectly against a housing 93 of the pedal 9 via a spring 98 and a washer 99. The other race member 96 abuts against the nut 92.

As described above, an apparatus is generally made up of a number of mechanical parts. The quality of the apparatus consists of several components like precision and accuracy in respective mechanical parts. Thus, if the number of mechanical parts is increased, the apparatus gains not only more weight but also an increase in accumulated tolerance and therefore causes a loss in the quality. Whilst the conventional apparatus as shown in FIG. 5 is satisfactory for most duties, there is always a desire to provide an apparatus with less weight and smaller accumulated tolerance.

### SUMMARY OF THE INVENTION

Accordingly, it is an object of the present invention to provide a thrust nut for bearing against an axle, which contributes less weight and smaller accumulated tolerance.

Specifically, the thrust nut includes a nut body, a first race member and a row of rolling elements. The nut body has opposing first and second surfaces and defines a threaded hole therein. The first race member is arranged to face the first surface of the nut body. The nut body serves as a second race member and cooperates with the first race member to co-define an annular track therebetween. The row of rolling elements is disposed in the annular track between the first race member and the nut body.

As described above, the thrust nut is merged from a conventional thrust bearing and a conventional nut in a manner that the weight of the thrust nut is less than a total weight of the thrust bearing and the nut, and the accumulated tolerance of the thrust nut is smaller than that of the thrust bearing and the nut.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a thrust nut in accordance with a first embodiment of the present invention;

FIG. 2 is an exploded perspective view of the thrust nut shown in FIG. 1;

FIG. 3 is a cross-sectional view of the thrust nut shown in FIG. 1, taken along line III-III;

FIG. 4 is a cross-sectional view of a thrust nut in accordance with a second embodiment of the present invention; and

FIG. 5 is a prior art.

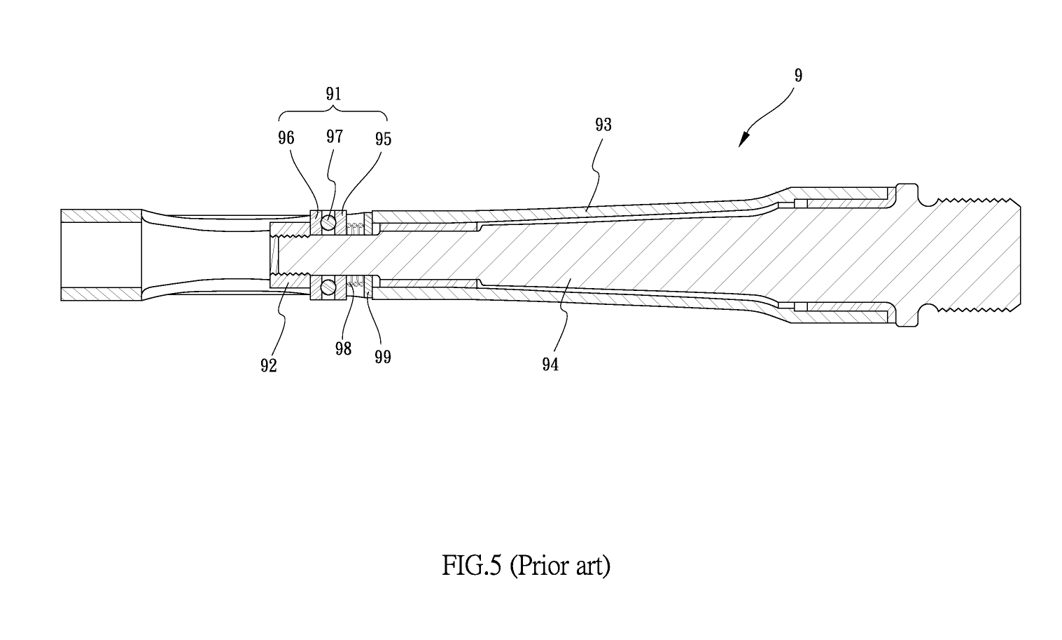

### DETAILED DESCRIPTION OF EMBODIMENTS

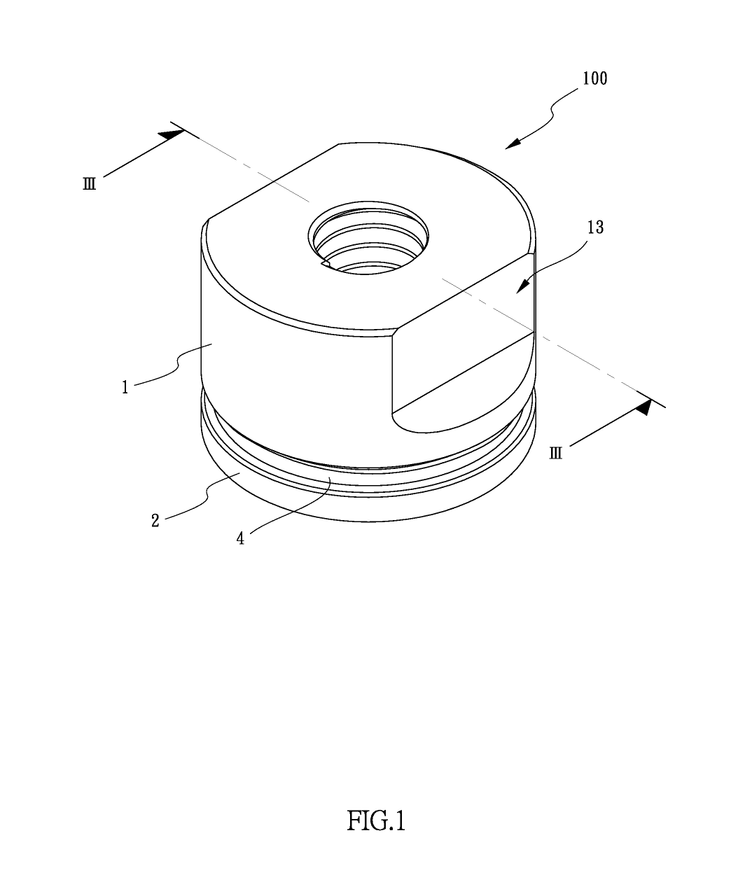

Referring to FIGS. 1-3, there is shown a thrust nut 100 for bearing against an axle according to a first embodiment of the present invention. As shown, the thrust nut 100 includes a nut body 1, a first race member 2, a row of rolling elements 3 and a retainer 4.

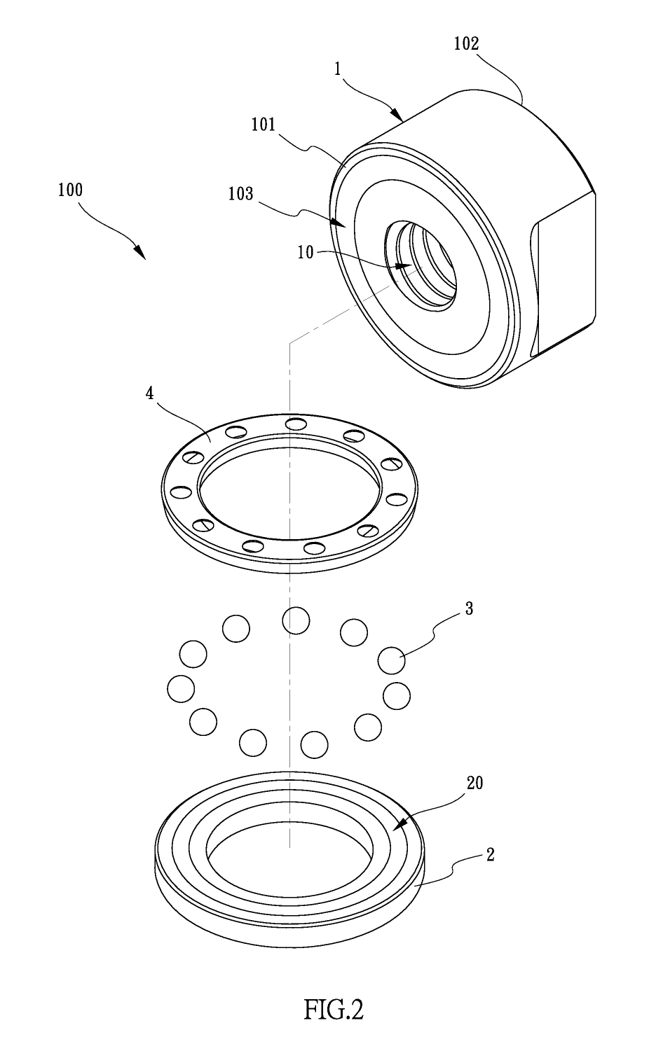

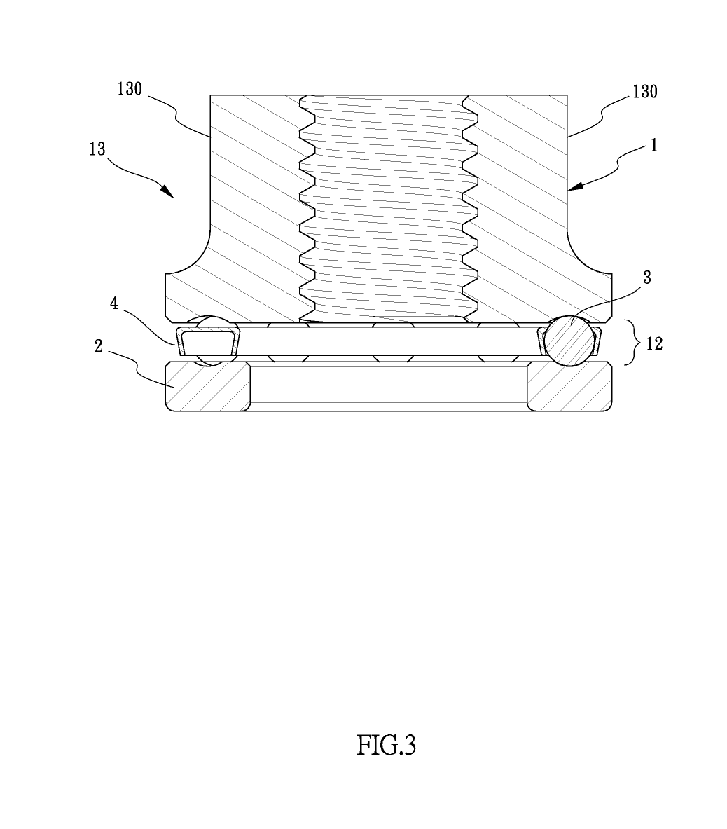

As shown in FIG. 2, the nut body 1 of the thrust nut 100 has opposing first and second surfaces 101, 102 and defines a threaded hole 10 therein. The first race member 2 faces the first surface 101 of the nut body 1. Moreover, the nut body 1 serves as a second race member and cooperates with the first race member 2 to co-define an annular track 12 therebetween, as depicted in FIG. 3. The row of rolling elements 3 is disposed in the annular track 12 between the first race member 2 and the nut body 1. In this example, the rolling elements 3 are spherical rotors; however, in other examples, the rolling elements 3 may be cylindrical rollers.

More specifically, as shown in FIG. 2, the nut body 1 defines an annular groove 103 in a periphery of the first surface 101 thereof. On the other hand, the first race member 2 defines an annular groove 20 axially opposing to that of the nut. body 1 such that the annular track 12 is formed between the nut body 1 and the first race member 2. In addition, the retainer or cage 4 is ring-shaped and sandwiched in between the nut body 1 and the first race member 2, as depicted in FIG. 3, so as to hold the rolling elements 3 from interacting one another.

As shown in FIGS. 2 and 3, the nut body 1 has at its second surface 102 an engaging portion 13 for engaging with a tightening tool (not shown). In this example, the engaging portion 13 of the nut body 1 is consisted of a pair of cutouts 130 at opposite sides of the nut body 1 for engaging with a fork spanner (not shown). However, in other examples, the engaging portion 13 of the nut body 1 may be a hexagonal recess for engaging with a hex key, a cross slot for engaging with a Phillips screwdriver, a straight slot for engaging with a flat-head screwdriver or an outside hexagon for engaging with a wrench.

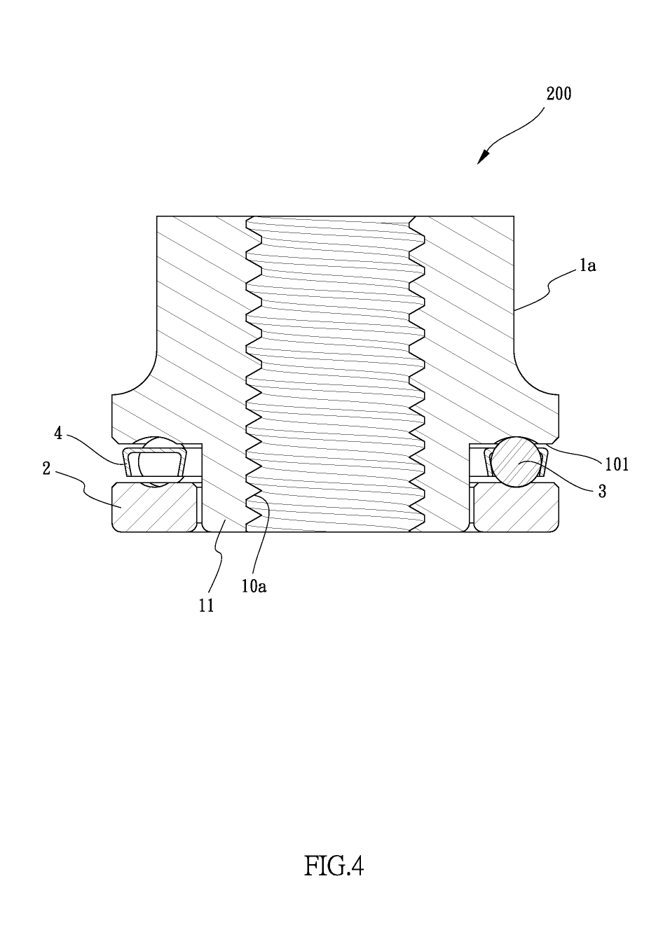

With reference to FIG. 4, there is shown a thrust nut 200 for bearing against an axle according to a second embodiment of the present invention. Similar to the thrust nut 100 in FIGS. 1-3, the thrust nut 200 of the second embodiment includes a first race member 2, a row of rolling elements 3 and a retainer 4, except that the nut body 1a is formed at its first surface 101 with a shank portion 11 around which the first race member 2 is disposed, and the threaded hole 10a of the nut body la extends through the shank portion 11.

As described above, the present invention provides a thrust nut that is merged from a conventional thrust bearing and a conventional nut and has characteristics of the two, but contributes less weight and smaller accumulated tolerance.

It is to be understood that the disclosed embodiments are illustrative in nature and the invention is not to be limited to any one or more embodiments except as set forth in the following claims.

What is claimed is:

1. A thrust nut for bearing against an axle, comprising:
a nut body having opposing first and second surfaces and defining a threaded hole therein;
a first race member facing the first surface of the nut body, wherein the nut body serves as a second race member and cooperates with the first race member to co-define an annular track therebetween; and
a row of rolling elements disposed in the annular track between the first race member and the nut body.

2. The thrust nut of claim 1, wherein the rolling elements are spherical rotors.

3. The thrust nut of claim 2, wherein the nut body defines an annular groove in a periphery of the first surface thereof, and the first race member defines an annular groove axially opposing to that of the nut body such that the annular track is defined between the nut body and the first race member,

4. The thrust nut of claim 1, further comprising a retainer that is ring-shaped and sandwiched in between the nut body and the first race member so as to hold the rolling elements from interacting one another.

5. The thrust nut of claim 1, wherein the nut body has at its second surface an engaging portion for engaging with a tightening tool.

6. The thrust nut of claim 1, wherein the nut body is formed at its first surface with a shank portion around which the first race member is disposed, and the threaded hole of the nut body extends through the shank portion.
